(19) United States
(12) Patent Application Publication
(10) Pub. No.: US 2019/0015914 A1
(43) Pub. Date: Jan. 17, 2019

(54) Reciprocating Cutting Device

(71) Applicant: Jose Medeiros, Hampton, NJ (US)

(72) Inventor: Jose Medeiros, Hampton, NJ (US)

(21) Appl. No.: 16/032,574

(22) Filed: Jul. 11, 2018

Related U.S. Application Data
(60) Provisional application No. 62/532,429, filed on Jul. 14, 2017.

(51) Int. Cl. B23D 61/18; B23D 57/00

(52) U.S. Cl. CPC B23D 61/185; B23D 57/0015; B23D 57/0053

(57) ABSTRACT

A cutting device comprising a drive assembly operably coupled to and powered by a drive means. The drive assembly comprises a worm gear operably coupled to and driven by the drive means, a crank assembly operably coupled to and driven by the worm gear, a timing assembly operably coupled to and driven by the crank assembly, an actuator assembly operably coupled to and driven by the timing assembly and a crank arm operably coupled to the crank assembly and the timing assembly. A drive cable extends from and is operably coupled to the actuator assembly. A flexible cutting means is operably coupled to the drive cable. The drive assembly is configured such that a reciprocating motion is transmitted to the cutting means such that the cutting means is reciprocated for cutting an article.

### CROSS-REFERENCE TO RELATED APPLICATION

This application claims priority to U.S. Provisional Application No. 62/532,429, filed on Jul. 14, 2017, which is incorporated by reference.

### BACKGROUND

The present invention relates to a cutting device which operates with a cutting means, preferably a flexible cutting means preferably of a linear configuration which is driven in a reciprocating manner by the cutting device.

Saws are devices which are commonly used to cut materials and/or articles. Saws generally fall into one of two categories, either a saw of the rotating type, where a continuous wheel typically having one or more teeth or abrasives on a peripheral edge of the continuous wheel is rotated against a material or article to be cut and cutting is achieved by the action of the teeth or abrasives on the material or article. The other category are reciprocating type saws, wherein a cutting material, which may be a blade having teeth or abrasives at a side thereof are moved in a back-and-forth, or in a reciprocating manner, against the material or article to be cut and cutting is achieved by the action of the teeth or abrasives on the material or article. In such reciprocating type saws, blades can be rigid, such as a linear rigid saw blade which is essentially inflexible (except for a limited degree of bending) or may be a linear flexible blade, which may for example be a chain, cable, or other flexible support means having associated therewith, or embedded in some or all parts thereof, one or more teeth and/or abrasive materials. Such linear flexible blades are particularly well adapted for the cutting of materials and/or articles which may be partially obstructed and pose problems of reduced accessibility to a person desirous of cutting a material or article. Such linear flexible blades also usually well adapted for cutting materials and/or articles which may be at some distance from the person desirous of cutting the material or article. In such a latter configuration, the length of the linear flexible blade can be extended much longer than are typical of linear rigid saw blades. For example, a conventional chainsaw useful in cutting trees, bushes, and other vegetation typically use a continuous linked chain, having cutting elements extending outwardly from one or more links of the chain. Such represents one type of a linear flexible blade. Another type of linear flexible blade includes a wire or cable support which is flexible, having an abrasive coating thereupon. Of course, both a combination of one or more cutting elements with an abrasive material can also be used with a linear flexible blade. Such a linear flexible blade may be continuous or may have two ends. Where such a linear flexible blade has two ends, a further cable, rope, chain, or other flexible article can be affixed to each end of the linear flexible blade, which can be used to effectively increase the length of the linear flexible blade, although the further cable, rope, chain or other flexible article affixed to the ends need not and usually do not have any cutters or abrasive materials thereon or associated therewith.

Known to the art are various devices which are disclosed being useful in cutting various materials and/or articles. For example, U.S. Pat. No. 1,743,057 discloses a stone sawing machine which includes a pair of opposed wheels and cable-type cutter which is moved in a continuous manner sliced through a stone block. U.S. Pat. No. 5,645,040 discloses a cable sewing machine for cutting concrete bodies, rocks, and the like. U.S. Pat. No. 1,457,761 discloses a timber felling apparatus which utilizes a flexible cable having a saw section which is mounted upon the cable. U.S. Pat. No. 1,903,518 discloses a stone saw which includes a flexible cable. U.S. Pat. No. 2,752,964 discloses a flexible hand saw having two ends, intermediate of which are a plurality of individual cutters mounted upon a flexible core extending and connecting the two ends. U.S. Pat. No. 3,958,332 discloses a cable saw which may be useful in felling timber. The cable saw includes spaced apart cutting links mounted to a continuous cable which is driven around a plurality of sprockets by a motor driven sprocket connected to a power source such as a gasoline engine. This last device requires that there be necessarily present two rigid arms extending from the drive socket in the direction of two further sprockets, one each present in a separate housing at the ends of each of the rigid arms, which provide a covering sheath for the cable saw and cutting links.

While the prior art suggests various cutting devices, these are not without one or more attendant shortcomings.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention provides a novel and inventive reciprocating cutting device which addresses and overcomes one or more of the shortcomings present in devices of the prior art.

In a first aspect, the present invention provides a cutting device, comprising: a drive means; a drive assembly operably coupled to and powered by the drive means, the drive assembly comprising: a worm gear operably coupled to and driven by the drive means, a crank assembly operably coupled to and driven by the worm gear, a timing assembly operably coupled to and driven by the crank assembly, an actuator assembly operably coupled to and driven by the timing assembly, and a crank arm operably coupled to the crank assembly and the timing assembly; a drive cable extending from and operably coupled to the actuator assembly; and a cutting means operably coupled to the drive cable, the cutting means being flexible; wherein the drive assembly is configured such that a reciprocating motion is transmitted to the cutting means such that the cutting means is reciprocated for cutting an article.

In another aspect, the present invention provides a cutting device, comprising: a drive assembly; a drive cable extending from and operably coupled to the drive assembly; and a cutting means operably coupled to the drive cable, the cutting means being flexible; wherein the drive assembly is configured such that a reciprocating motion is transmitted to the cutting means.

In yet another aspect, the present invention provides a cutting device, comprising: a drive assembly; a drive cable having a cutting means, the drive cable extending from and operably coupled to the drive assembly, the drive cable being flexible; wherein the drive assembly is configured such that a reciprocating motion is transmitted to the drive cable.

These and further aspects of the invention are disclosed in the following parts of this patent specification and drawings.

### BRIEF DESCRIPTION OF THE DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is an illustration of an embodiment of a reciprocating cutting device of the present invention in an operable state;

FIG. 2 is an exploded view of an embodiment of a drive assembly of the device of the present invention;

FIG. 3 is another exploded view of the drive assembly of FIG. 2;

FIG. 4 is a top perspective view of the drive assembly of FIG. 2 in an assembled state;

FIG. 5 is a perspective view of an embodiment of a crank assembly of the device of the present invention in an assembled state;

FIG. 6 is an exploded view of the crank assembly of FIG. 5;

FIG. 7 is an exploded view of an embodiment of a timing assembly of the device of the present invention;

FIG. 8 is a perspective view of the timing assembly of FIG. 7 in an assembled state;

FIG. 9 is a perspective view of an embodiment of an actuator assembly of the device of the present invention in an assembled state;

FIG. 10 is an exploded view of the actuator assembly of FIG. 9;

FIG. 11A is a plan view of the crank assembly of FIG. 5 and timing assembly of FIG. 7 coupled together with an embodiment of a crank arm of the device of the present invention in a first position;

FIG. 11B is a plan view of the structural combination of FIG. 11 in a second position;

FIG. 11C is a plan view of the structural combination of FIG. 11 in a third position;

FIG. 11D is a plan view of the structural combination of FIG. 11 in a fourth position;

FIG. 12A is a plan view of an embodiment of a cutting means of the present invention;

FIG. 12B is a plan view of another embodiment of a cutting means of the present invention;

FIG. 13A is a perspective view of an embodiment of a connector of the present invention;

FIG. 13B is a perspective view of another embodiment of a connector of the present invention; and

FIG. 14 is a partially exploded view of an embodiment of a cutting device of the present invention; and

FIG. 15 is a plan view of another embodiment of a reciprocating device of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

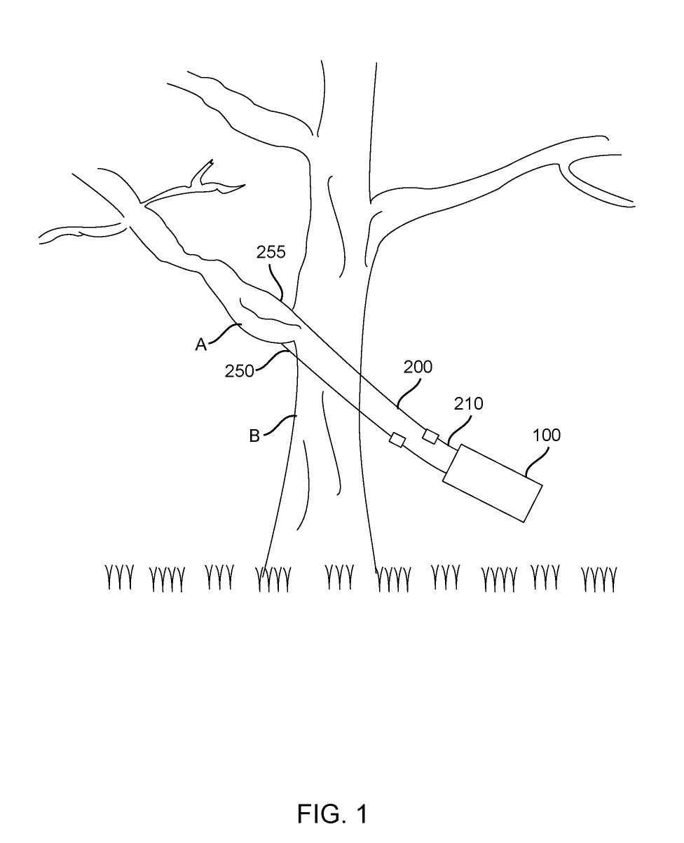

FIG. 1 depicts a manner of using cutting device 100 of the present invention in conjunction with a cutting means 250. As illustrated in the figure, a portion of the cutting means 250 upon which are one or more cutters 255 are located is seen to be looped about a part of a tree limb A which extends outwardly from a tree trunk B. As is readily understood from the figure that the relative positioning of the cutting device 100 is offset and not underneath the tree limb A so that when the cutting device 100 is operated and the cutting means 250 ultimately saws off the tree limb the A it may fall to the ground location offset from the position of an operator of the cutting device 100, thereby assuring an improved degree of safety. While not seen in the figure, is to be understood that the initial placement of the cutting means 250 and its cutters 255 can be done by disengaging at least one end of the cutting means 250 from the cutting device 100 and as the cutting means 250 is desirably flexible, the disengaged end can be looped around the tree limb A at a desired position, and the previously disengaged end can be reengaged with a part of the cutting device 100. The operator of cutting device 100 then typically will impart some degree of tension by pulling the cutting device 100 in a direction away from the tree limb A which will ensure that the cutters 210 engage the tree limb A while it is being cut off. The flexible nature of the cutting means 250 allows for the relative location of the cutting device 100 to be repositioned before and during operation of the cutting device 100, e.g., allows for the operator to move to a different position or location before, during or even after the operation of the cutting device 100.

While the use of a cutting device 100 in removing a tree limb is illustrated in FIG. 1, it is to be clearly understood that such an operation is merely presented by way of illustration, not by way of limitation. The cutting device 100 can be used, in conjunction with a cutting means 250 in any manner in which it is desired to cut, slice, or separate material and/or article into separate parts. Such materials can be naturally growing materials, including plants, trees, brush, bushes, vegetative growth and the like, and can also be so-called building material such as timber, lumber, stone, masonry, pipes, rods, and the like. Advantageously, the cutting device 100 and cutting means 250 are used in a cutting operation wherein there is restricted or limited access to a location of a material and/or article desire to be cut. The felling of overhead tree limbs is but a single example. The severing of pipes, cables or rods particularly as may be located in enclosed or confined spaces provides an alternative example of a use of the cutting device 100 and cutting means 250. The cutting of pipes, such as soil pipes, drainpipes, water supply pipes, gas pipes, HVAC ducts and the like often are problematic particularly when such are installed in buildings, or vehicles are advantageously accomplished by use of a cutting device 100 and cutting means 250. The cutting means 250 can be temporarily detached from the cutting device 100, positioned around or against a portion of a material and/or article, and reattached to the cutting device 100, which can then be activated, imparting a reciprocating motion to the cutting means 250 to cut or sever such a material and/or article.

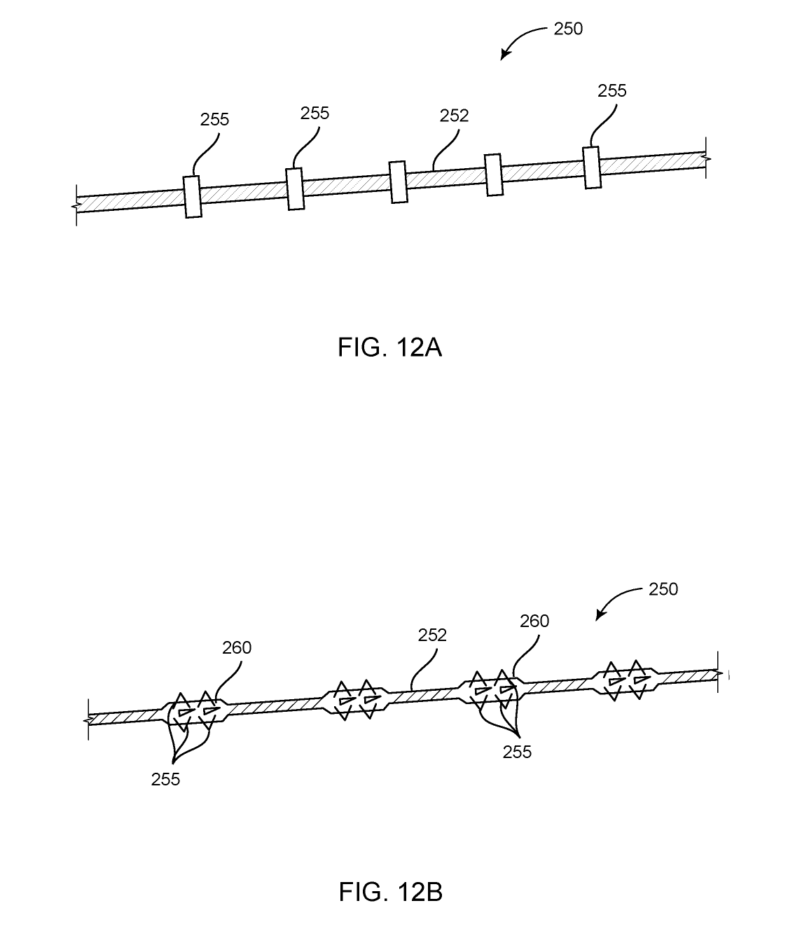

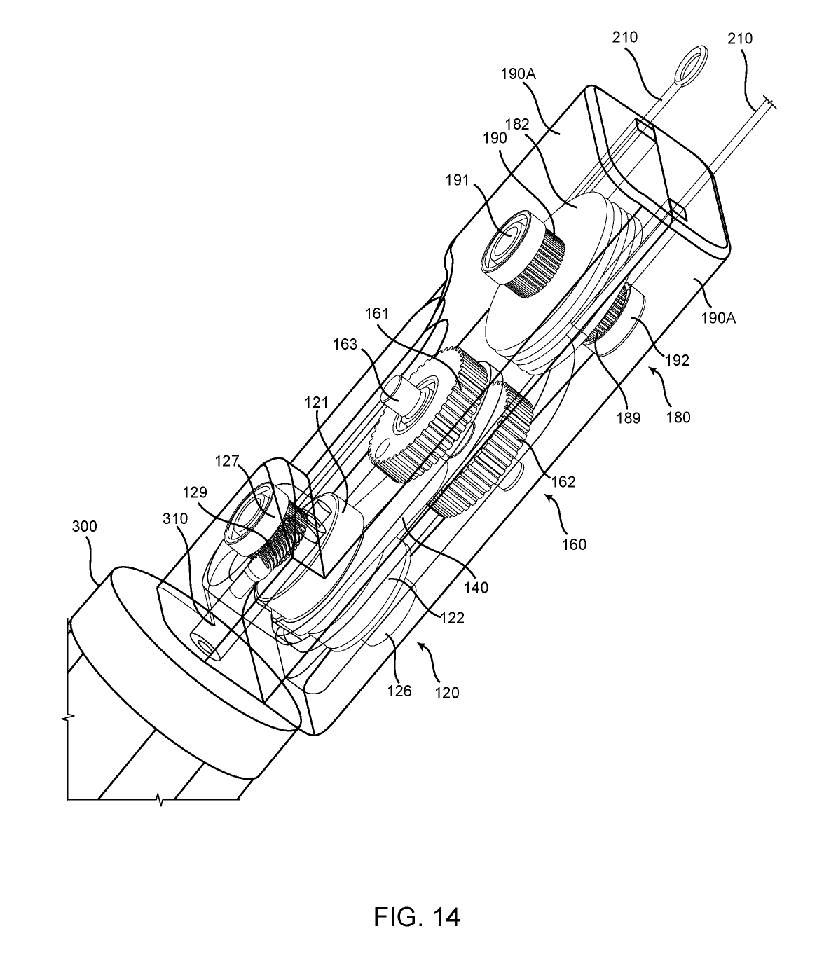

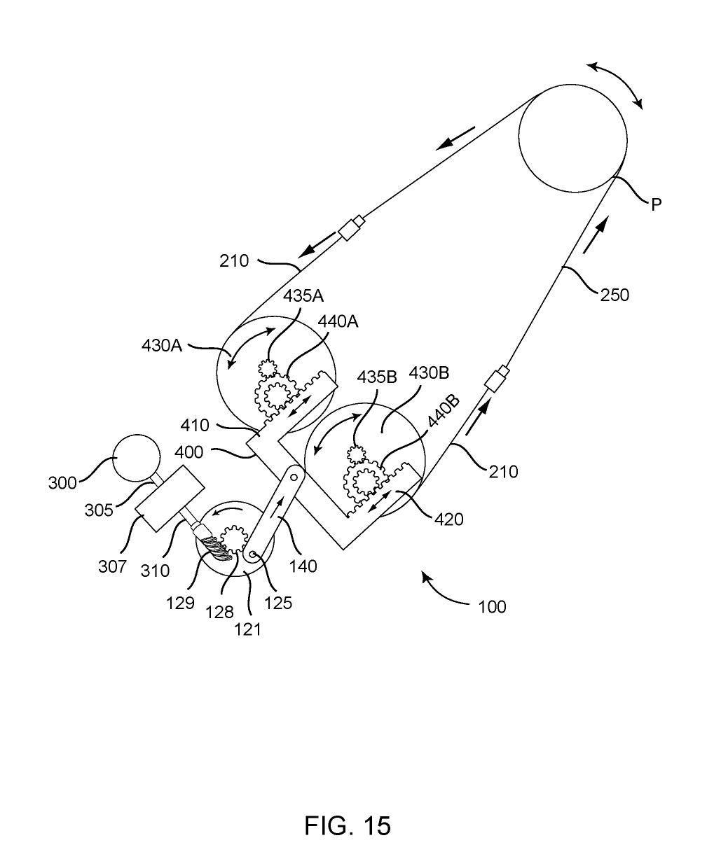

Two preferred embodiments of a cutting device 100 are shown for example in FIGS. 14 and 15, and preferred embodiments of cutting means 250 shown for example in FIGS. 12A and 12B, are discussed below.

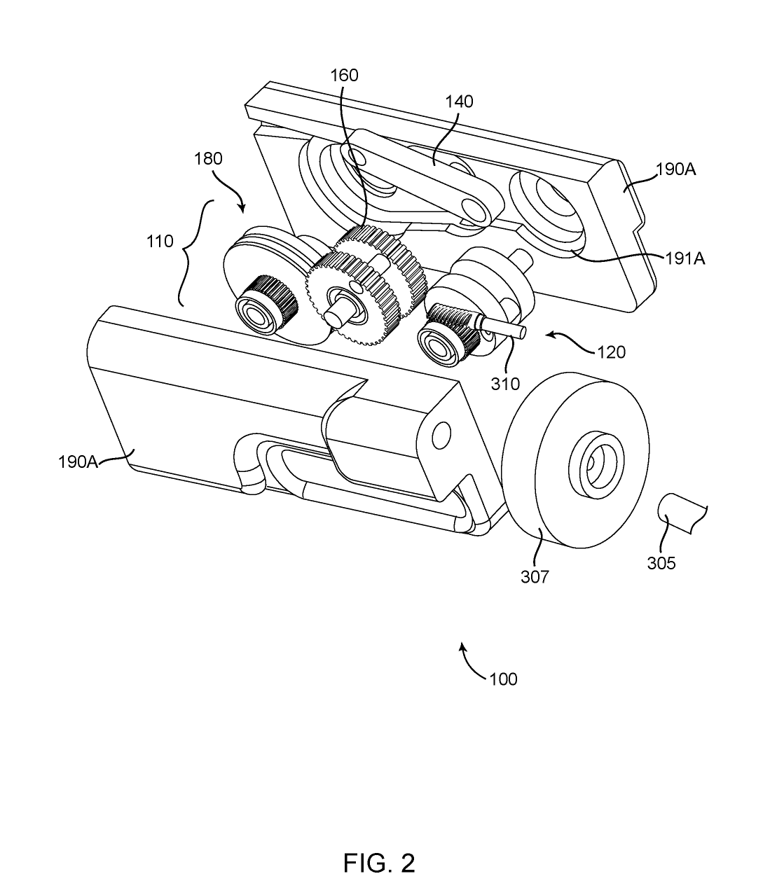

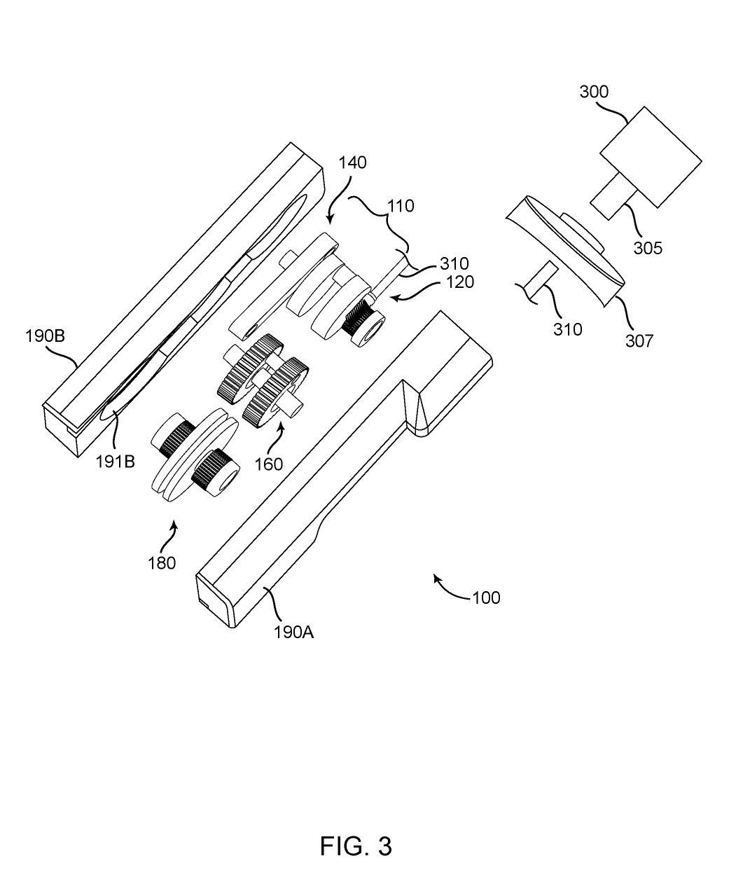

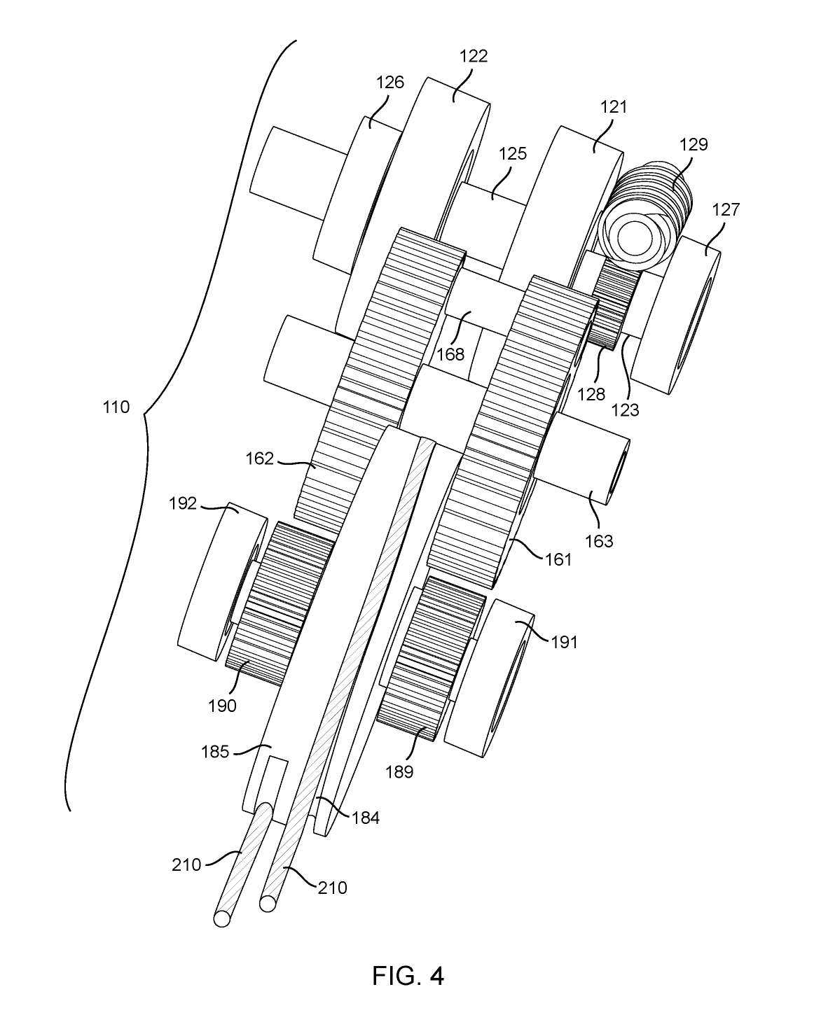

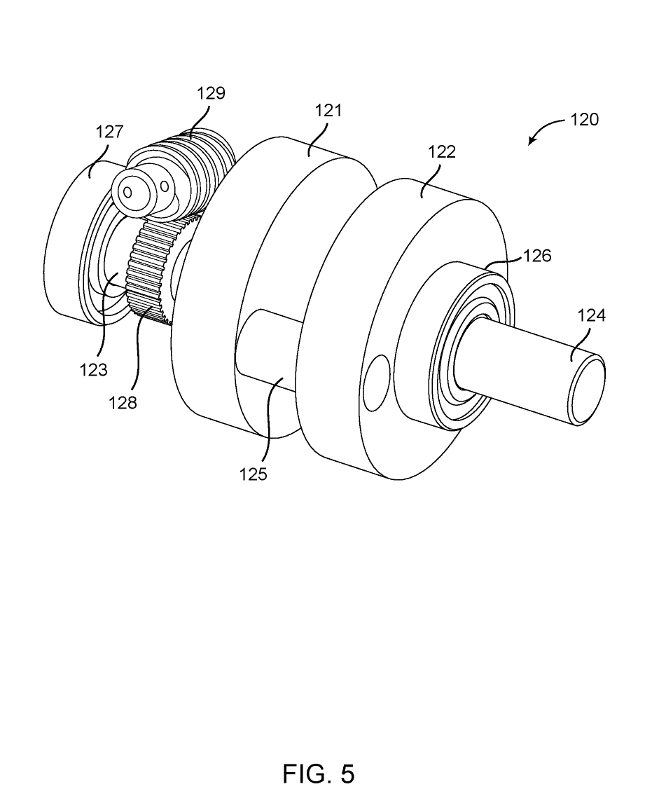

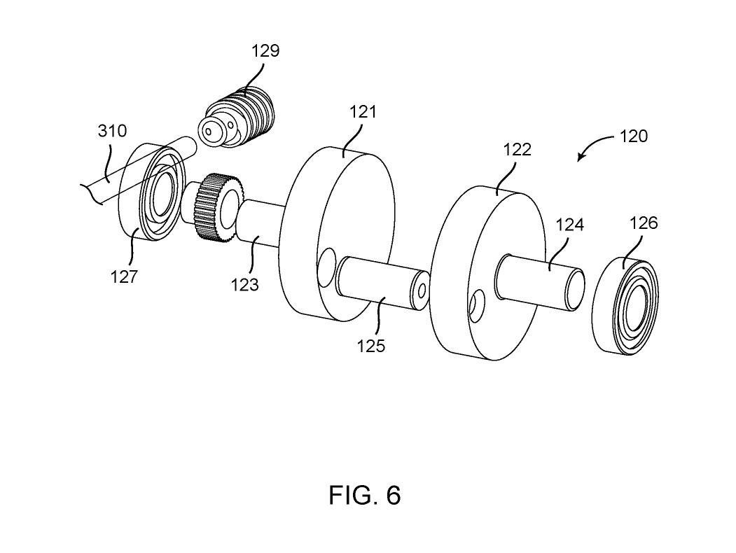

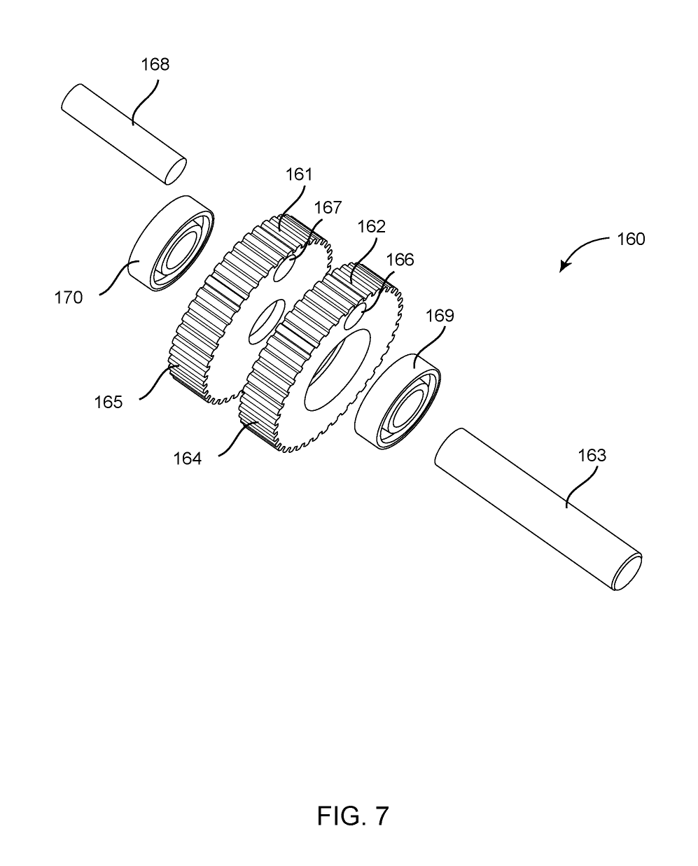

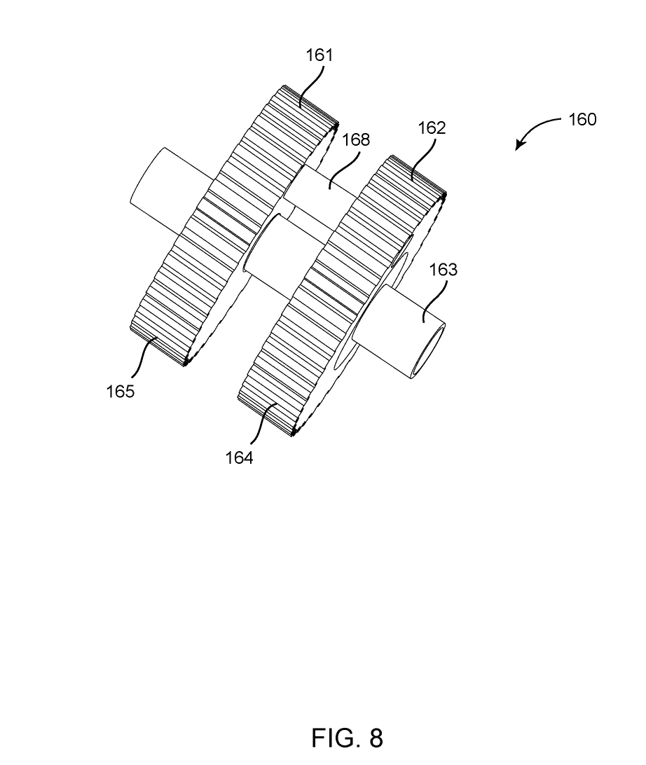

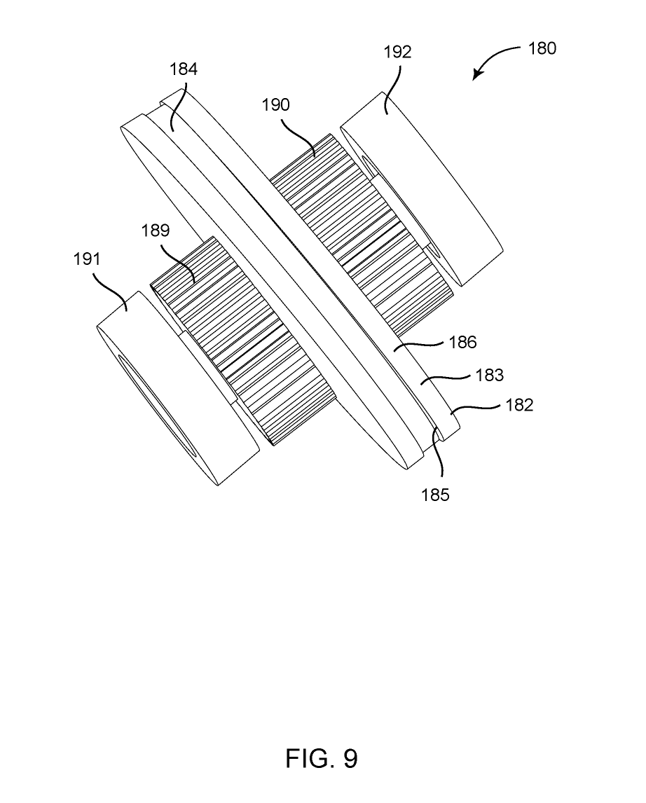

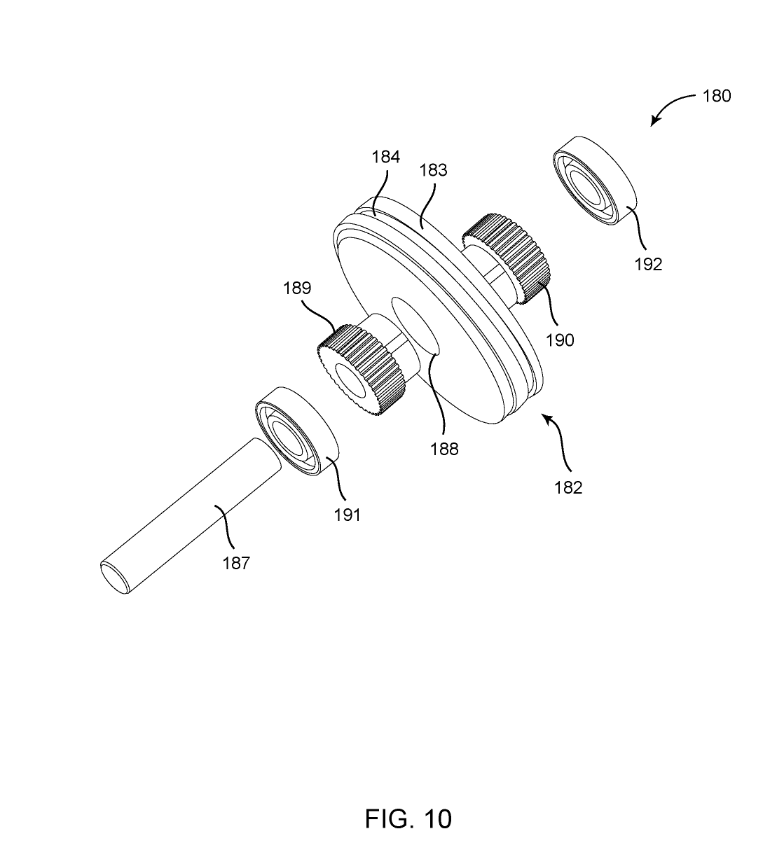

FIGS. 2 and 3 illustrate portions of a cutting device 100 in an exploded view which provide useful depictions of the elements forming a drive assembly 110 which is used to convert a rotary motion imparted to one part of the drive assembly 110, such as by a drive means 300 having a rotating output shaft 305, to a reciprocating motion at another part of the drive assembly 110. As is seen these two figures, the elements of the drive assembly 110 include a crank assembly 120, connected by a crank arm 140 to a timing assembly 160, which in turn operates with an actuator assembly 180. The drive assembly 110 is advantageously provided in a closed frame assembly 190A, 190B which contains the parts of the drive assembly 100 and maintains them in a relative operative arrangement during the operation of the cutting device 100. An enlarged view of the parts of the drive assembly 110 are shown in FIG. 4 which depicts each of the crank assembly 120, timing assembly 160, and actuator assembly 180. A more detailed view of the crank assembly 120 is illustrated in FIGS. 5 and 6. A more detailed view of the timing assembly 160 is shown in FIGS. 7 and 8. A more detailed view of the actuator assembly 180 is shown in FIGS. 9 and 10.

Reference is made to FIGS. 5 and 6, in which FIG. 5 illustrates a perspective view a crank assembly 120 and in FIG. 6 illustrates the same crank assembly 120 albeit it in an exploded view in order to show the individual component parts thereof. The crank assembly includes two spaced apart wheels 121, 122 each having a central bore to which extends a central shaft 123, 124, as well as an offset bore which is used to contain a link shaft 125. The central shaft 123, 124 is optionally, but preferably provided with suitable bearings 126, 127 mounted upon the central shaft 123, 124 which allow for rotational motion. Any suitable bearings can be used including, for example, ball bearings, roller bearings, sleeve bearings and the like. Also, while not shown, it is to be understood that one or more parts or elements may be journaled or otherwise configured to receive one of more suitable bearings within the cutting device 100. When rotating, the spaced apart wheels 121, 122 rotate about their central shafts 123, 124, each of which is concentric with the other, which causes the link shaft 125 to rotate in an offset manner relative to the rotational axis of the wheels 121, 122. Further illustrated in the figure, and mounted upon one of the central shafts, here central shaft 123 is worm gear 128 which is mechanically coupled or otherwise affixed to the central shaft 123. A corresponding drive worm 129 is also provided, which is enmeshed with the worm gear 128 so that rotational motion, such as may be imparted by driveshaft 310, engages said the worm gear 128 and causes it, its corresponding central shaft 123 and thereby the entire crank assembly 120 to rotate.

With reference to the operation and the rotation of the crank assembly 120, while the disclosed embodiment utilizes an enmeshed worm gear 128 and drive worm 129 in order to cause rotation of the crank assembly 120 about the central shafts 123, 124, is to be understood that other drive means may be utilized to provide a similar result. For example, the enmeshed worm gear 128 and drive worm 129 may be omitted and instead, a pulley assembly may be provided in its place, with a part of the pulley assembly being driven by a belt or chain connected to a drive means 300, such as an electric motor, gasoline or diesel engine (usually via an intermediate clutch assembly) or even an air driven motor which operates in response to the supply of compressed air. Alternatively, a “direct drive” is also possible, wherein one or both of the central shafts 123, 124 a couple to, or forms part of a shaft of an electrical motor, whose rotational speed can be controlled such as by controlling the current supply to such an electrical motor. Alternatively, in place of the drive worm 129, a gearbox having one or more gears mechanically coupled to a drive source can be supplied. The gearbox could include at least one gear which is in mechanical engagement with one or both of central shafts 123, 124 which may be either directly or gear mounted upon a part of one or both of central shafts 123, 124. Indeed, any means which is useful in providing rotational motion to the crank assembly 120 is contemplated as being useful in conjunction with the present invention.

Reference is made to FIGS. 7 and 8, in which FIG. 8 depicts the timing assembly 160 in a perspective view, while in FIG. 7 an exploded view of the timing assembly 160 is provided. Timing assembly 160 includes two gears 161, 162 which are both concentrically mounted upon a central support shaft 163 passing through the center of both gears 161, 162. The outer peripheral surface of each of the gears 161, 162 include matched sets of equally sized teeth 164, 165. Each of the gears 161, 162 further include an offset bore 166, 167 suitably sized to accommodate a link shaft 168 which extends between the two gears 161, 162, and is parallel to, but offset from the central support shaft 163. Optionally, but preferably as is disclosed in FIGS. 7 and 8, the timing assembly 160 includes a pair of bearings 169, 170 mounted upon the central support shaft 163 which allow for rotational motion of the gears 161, 162 thereabout. As recited before, any suitable bearings can be used including ball bearings, roller bearings, sleeve bearings and the like.

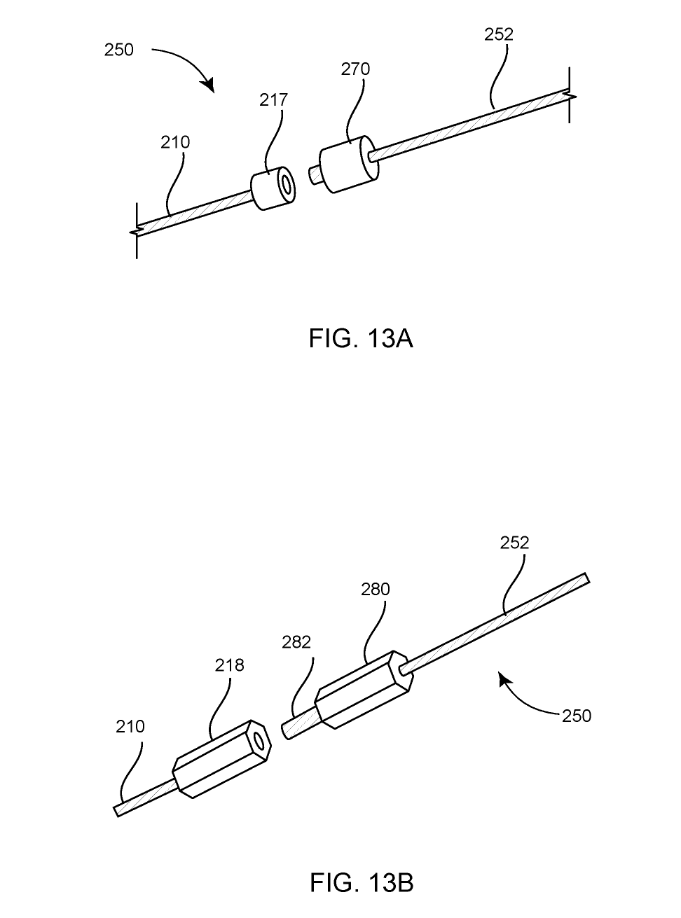

Reference is now made to FIGS. 9 and 10 which depict the actuator assembly 180, FIG. 9 being a perspective view and FIG. 10 being an exploded view. The actuator assembly 180 includes a central wheel 182 having upon its periphery 183 at least one continuous or semi-continuous groove 184 which extends about a portion of the periphery 183. Preferably, the groove 184 is recessed inwardly from the face 185 of the central wheel 182 so that you find a recessed groove extending inwardly from the face 185, and is sized to accommodate a drive cable 210, as shown for example in FIGS. 1, 13A and 13B. In the depicted embodiment, a semi-continuous groove 184 is provided. The groove 184 has two ends, one end 186 being visible in FIG. 9. It is to be understood that the drive cable 210 could be two separate cables with an end of one drive cable 210 anchored or affixed to the central wheel 182 so that the end of the drive cable 210 terminates at or near the end 186, while an end of the other drive cable 210 is similarly anchored or fixed at or near another end (not shown) of the semi-continuous groove 184. Alternatively, the drive cable 210 could be one continuous cable and not attached to either of the ends (e.g, 186) of the semi-continuous groove 184, but may be merely wrapped about a part of the periphery 183. The semi-continuous groove 184 preferably extends 360° around the periphery 183 of the central wheel 182 so that at least a part of the drive cable encircles the periphery of the central wheel 182 and is retained within the semi-continuous groove 184. Such a relationship between drive cable 210 and the groove 184 provides dual benefits. A first benefit is that the part of the drive cable 210 encircling of the central wheel 182 provides a good frictional surface between itself and the central wheel 182 and distributes any tension present within the drive cable 210 generally uniformly about a portion of the periphery of the central wheel 182. A second benefit is that as the actuator assembly 180 operates, the central wheel 182 only partially rotates and rotates in a reversible “back-and-forth” manner so that the parts of the drive cable 210 coming in contact with the central wheel 182 is retained within the groove 184. The actuator assembly 180 further includes a central shaft 187 passing through a central bore 188 of the central wheel 182. A pair of correspondingly sized and dimensioned drive gears 189, 190 are also mounted around the central shaft 187 on opposite sides of the central wheel 182 and are mechanically coupled with the central wheel 182. Again, optionally but advantageously, a pair of bearings 191, 192 are also mounted upon the central shaft 187 which allows for rotational motion of the central wheel 182 and gears 189, 190 thereabout. As recited before, any suitable bearings can be used including ball bearings, roller bearings, sleeve bearings and the like.

Although the embodiment of the actuator assembly 180 is illustrated having a groove 184, it is nonetheless to be understood that such is not essential to the operation of the present invention. In alternative embodiments, the actuator assembly 180 comprises a central wheel 182 which may have a single channel extending completely or only partially around the periphery of the central wheel 182. In another embodiment the actuator assembly 180 includes a central wheel 182 which lacks any groove 184 or recess extending inwardly from the face or peripheral surface 185 thereof but advantageously includes one or more rims or sidewalls extending outwardly from the periphery 183 and the edges of the periphery 183 thereby defining an alternative embodiment of a groove other than what is specifically disclosed in the figures. In such an embodiment, the drive cable is retained between the one or more rims or sidewalls so that the drive cable is retained against the peripheral surface 185 of the central wheel 182 while the cutting device 100 operates.

FIG. 4 depicts in a perspective view the crank assembly 120, the timing assembly 160 and the actuator assembly 180 in a near-correct depiction illustrating the relative positions of each. It is to be noted that the crank assembly 120 shown as slightly offset in FIG. 4 for purposes of clarity, but its position with respect to the timing assembly 160 is more accurately depicted in FIGS. 2 and 3. That is, the link shaft 125 of the crank assembly 120 is aligned with the link shaft 168 of the timing assembly 160. Also, the position placement of the crank arm 140 is also omitted from FIG. 4, but its location and engagement is discussed with reference to the crank assembly 120 and timing assembly 160 with reference to FIGS. 2 and 3. As it is understood from the view provided in FIG. 4, the rotation of the drive worm 129 which is engaged with worm gear 128 imparts rotation (clockwise, counterclockwise) to the crank assembly 120 and its two wheels 121, 122 causing them to rotate. The link shaft 125 present between the two wheels 121, 122 also correspondingly rotates. A part of the crank arm 140, at one end thereof, is operatively coupled (not shown) to the link shaft 125, and as the crank assembly 120 rotates, a part of the crank arm 140 travels with the link shaft 125. The other end of the crank arm 140, at another and thereof, is operatively coupled (not shown) to the link shaft 168 which extends between the two gears 161, 162 of the timing assembly 160. The length of the crank arm 140 is limited such that as the crank assembly 120 rotates, the interlinked crank arm 140 imparts only a reversible, partial rotation of a reciprocating nature to the timing assembly 160.

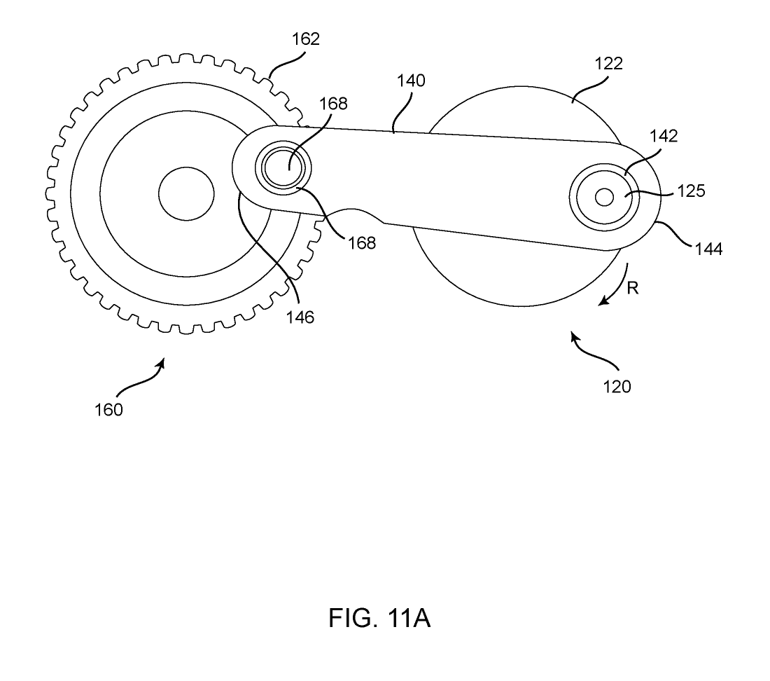

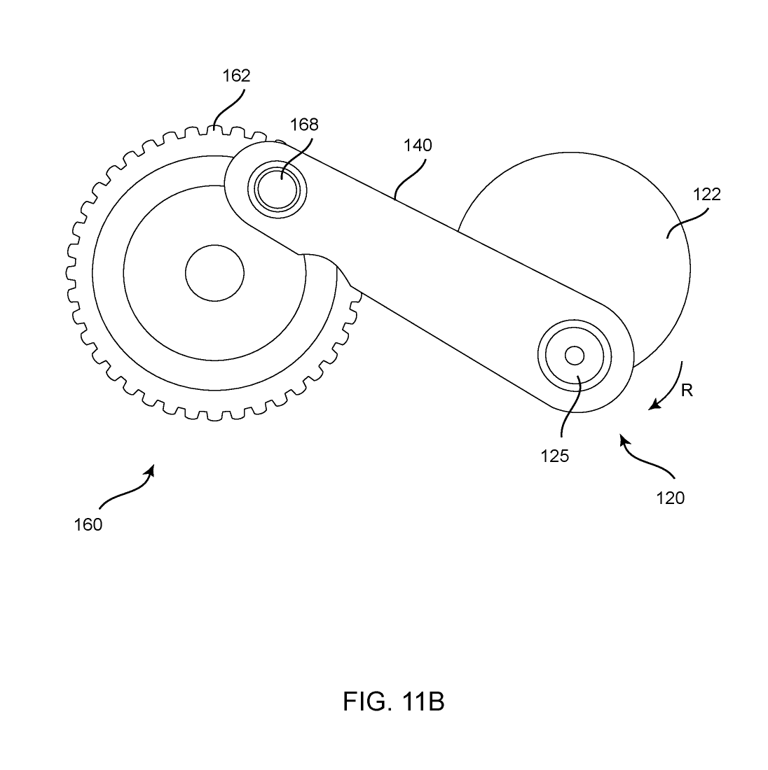

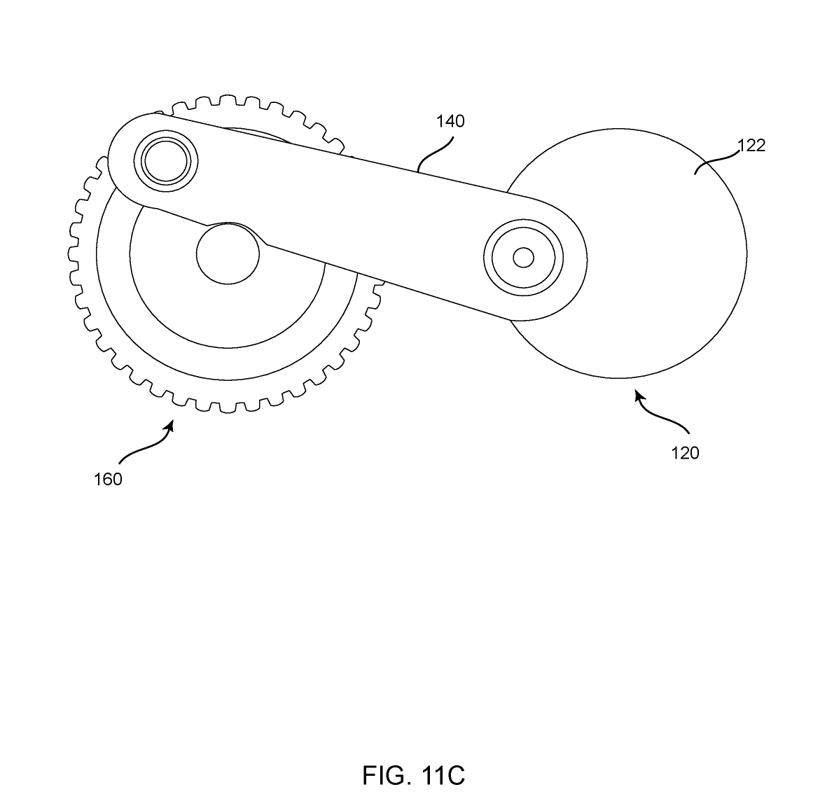

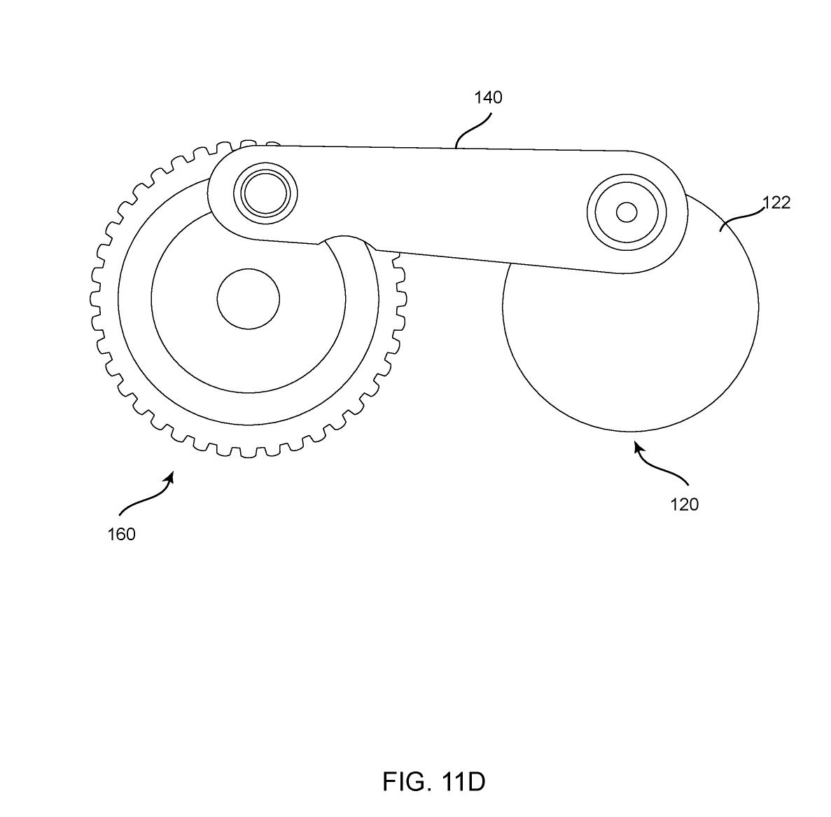

This is understood with reference to further drawing FIGS. 11A, 11B, 11C and 11D which illustrates the manner in which the crank arm 140 is operatively connected to parts of the crank assembly 120 and the timing assembly 160. As is visible therefrom, a bore 142 passes through one end 144 of the crank arm 140 and the link shaft 125 extends through the bore 142. Another end 146 of the crank arm 140 is distally located from end 144, which includes a second bore 148 through which passes link shaft 168. While not shown, advantageously each of the link shaft 125 and link shaft 168 are mounted to respective bores 142, 148 via bearings. As recited before, any suitable bearings can be used including, for example, ball bearings, roller bearings, sleeve bearings and the like. In each of FIGS. 11A, 11B, 11C and 11D, the rotation of the wheel 122 is in a single, here a clockwise, direction (although rotation in a counter-clockwise direction is equally effective) throughout the drawing figures, but the rotation of the gear 162 of the timing assembly 160 only undergoes a reversible, partial rotation of a reciprocating nature. In FIG. 11A, the relative position of the crank arm 140 is at a ‘dead center’ location, and the gear 162 of the timing assembly 160 is static. In the next FIG. 11B, the wheel 122 has undergone 90° of further clockwise rotation, and gear 162 of the timing assembly 160 has undergone movements in a counter-clockwise direction. In the next FIG. 11C, the wheel 122 has undergone a further 90° clockwise rotation, which has caused displacement of the crank arm 140 as depicted, during which interval the rotation of the gear 162 of the timing assembly 160 has undergone a further counter-clockwise rotation. In FIG. 11D, the wheel 122 has undergone a further 90° clockwise rotation, and the direction of travel of gear 162 of the timing assembly 160 has been reversed and rotates in a clockwise direction. Thereafter with a final further 90° of further clockwise rotation of wheel 122, the arrangement returns to the configuration depicted in FIG. 11A. As can be understood from the foregoing, a complete rotation of the wheel 122 forming part of the crank assembly 120 causes only a partial rotation of the timing assembly 160, which reciprocates and reverses its direction of rotation at least once per complete rotation of the wheel 122.

Returning now to FIG. 4, the further operation of the drive assembly 110 is better understood. It is also better appreciated from FIGS. 11A-11D that the crank arm 140 is located between wheels 121, 122 and gears 161, 162. Drive gears 189 of the actuator assembly 180 are enmeshed with gears 161, 162 of the timing assembly 160 and are driven thereby in a corresponding reciprocating manner so that the central wheel 182 is rotated in a reversible rotational manner which reverses when the rotational direction of the timing assembly 160 reverses its rotational direction. A portion of the drive cable 210 is wrapped around a part of the surface 185 of the central wheel 182 and in the depiction, is engaged in the groove 184. In view of the foregoing, it is now understood that the drive cable 210 will be moved in a back-and-forth, reciprocating direction, in conjunction with the corresponding motion of the central wheel 182.

Returning now to FIGS. 2 and 3, the elements of the drive assembly 110 are illustrated, again in and exploded view, but here the crank arm 140 is also depicted. The drive assembly 110 is advantageously provided in a closed frame assembly 190A, 190B which contains the parts of the drive assembly 100 and maintains them in a relative operative arrangement during the operation of the cutting device 100. The parts 190A, 190B of the closed frame assembly include corresponding suitably sized recesses 191A, 191B which provide support for one more shafts against one or more bearings of the crank assembly 120, the timing assembly 160 and the actuator assembly 180, as well as to permit for their relative motions, as well as that of the crank arm 140. Preferably, as depicted in FIGS. 2 and 3, the parts 190A, 190B of the closed frame assembly encase the drive assembly 110 so to ensure that their moving parts are physically operated from a user operator of the cutting device 100. A sealed closed frame assembly also permits for permanent lubrication to be applied to the parts of the drive assembly 110.

The drive assembly 110 is operatively attached to a drive means 300 having a rotating output shaft 305. Suitable drive means 300 may be any device which provides sufficient rotational energy to the drive assembly 110. Advantageously, the suitable drive means may be an electric motor, a fuel burning mechanical engine, such as a gasoline, diesel (or other hydrocarbon fuel) powered engine (usually via an intermediate clutch assembly) or an engine driven by a supply of a compressed gas, e.g, compressed air. The drive means 300 may either directly coupled to the driveshaft 310 (i.e., “direct drive”) or indirectly coupled, such as via an intermediate device such as the depicted clutch assembly 307, wherein the shaft 305 of the drive means is attached to the clutch assembly 307 and further parts of the clutch assembly 307 are attached to the driveshaft 310. The drive means 300 may be incorporated into the construction of the cutting device 100. Alternatively, the drive means 300 may be removably attached to the cutting device 100. For example, a handheld motor or apparatus having a suitable clutch, chuck or spindle is engaged with a part of the cutting device 100 and after use of the cutting device 100 is completed, it may be disengaged. Examples of such handheld motors or apparatus include common power tools such as electrically operated or battery-powered drills, reciprocating linear saws (e.g. Sawzall) and the like.

The drive means 300, if incorporated in the construction of the cutting device 100, may be powered by any suitable source. Non-limiting examples include permanently installed batteries, removable batteries and battery packs, which can be of the single use type or may be recharged a plurality of times, as well as direct collection to electrical power, wherein the drive means 300 is electrically operable. The drive means 300 could also be engine powered by hydrocarbon fuel, a tank, canister, storage cartridge and the like may be either included as part of or may be provided as a refill, preferably a detachable refill element to the cutting device. Where the drive means 300 is operative in response to a pressurized gas, a suitable connection port(s) may be provided, whereby the cutting device 100 can be easily coupled, typically via a hose, to a supply of compressed gas, e.g., an air compressor or tank of a compressed gas.

As previously discussed, the cutting device 100 is used in conjunction with a cutting means 250. In preferred embodiments, as are depicted in FIGS. 12A, 12B the cutting means 250 include a core 252 having located at least upon a part thereof, one or more cutters 255. Core 252 is necessarily generally linear, and flexible. Preferably one or more cutters 255 may be mounted upon part of the core 252. Non-limiting examples of a suitable core 252 include single or multi-stranded wires or cables, non-metallic cords or ropes, tapes, bands and the like. Materials of construction are not critical to the operation of the cutting means to 250 and it is only required that the core 252 exhibit satisfactory tensile strength so that it does not prematurely snap or break when the cutting means to 250 is being used. One or more cutters 255 are desirably present upon one or more parts of the core 252. Two preferred embodiments are illustrated in FIGS. 12A and 12B. In FIG. 12A, a plurality of spaced apart cutters 255 are illustrated surrounding a part of the core 252 of a cutting means 250. Here, ring-shaped elements of a durable material, such as a metal, are provided as cutters 255 and are brazed to a multi-strand twisted wire cable at several spaced apart positions. In FIG. 12B, a plurality of cutters 255 are present on each of a number of cutter mounts 260 which at least partially encircle a wire cable, which is a suitable core 252, and the cutter mounts 260 are affixed at one or more parts of the wire cable, e.g., by crimping, welding or brazing.

Also, while not shown in the drawings, it is to be understood that a very suitable cutting means 250 can be provided solely by a core 252, whose surface may be suitably abrasive in order to provide an effective cutting surface for use with a particular material. For example, wire cable formed from individual twisted wires and/or braided wires may have sufficient surface abrasiveness to be effectively used on certain materials and/or articles. Alternatively, a cable or stranded cord formed of one or more strands or filaments of a naturally occurring material (e.g., hemp) and/or one or more strands or filaments of a synthetic polymer material may be suitably used as a cutting means 250, without or without further provision of cutters 255.

Also, while not shown in the drawings, it is to be understood that a suitable cutting means 250 can be provided by a core 252 which is provided with a surface treatment whereby an additional abrasive material is applied to a part of or the entire surface of the core 252. Such a surface coating can be continuous, discontinuous, but preferably in at least a part of the cutting means 250 such that the surface treatment encloses the core 252 in a continuous or sheath-like manner about the surface thereof. Non-limiting examples of such include an abrasive material, such as a metal oxide or other minerals which may be adhered to the surface of the core 252.

The cutting means 250 may also include one or more interconnected links or elements, e.g, a chain, preferably a chain having one or more cutting elements as are known from chainsaw devices used in felling trees.

While the cutting means 250 may be continuous and form an “endless loop” (a part of which is wound about a part of the wheel 182 of the cutting device 100), advantageously, the cutting means 250 has two ends with each end having a coupling means which cooperatively engages with corresponding coupling means attached to part of the drive cable 210 of the cutting device 100. Two non-limiting examples of such are disclosed in FIGS. 13A and 13B. In one embodiment, shown in FIG. 13A, at one end of the cutting means 250, the core 252 terminates as a part of a bayonet-type connector 270, which is engageable with a corresponding bayonet-type connector 217 which is affixed to an end of the drive cable 210. Bayonet-type connector 270 forming part of the cutting means 250 may be releasably engaged with the corresponding bayonet-type connector 217 located at an end of the drive cable 210. While not shown, a similar bayonet-type connector 270 is also present on the other end of the cutting means 250 and engages a further corresponding bayonet-type connected 217 affixed to the other end of the drive cable 210. In another embodiment, shown in FIG. 13B, at one end of the cutting means 250, the core 252 terminates as part of a screw-type connector 280 having a hexagonal shaft, and extending therefrom is a threaded screw 282, which is engageable with the corresponding connector 218 affixed to an end of the drive cable 210. A similar screw-type connector 280 is present at the other end of the cutting means 250. Each of the screw type connectors 280 may be screwed, or unscrewed as desired and may be releasably engaged with the drive cable 210 of the cutting device. It is to be expressly understood that the apparatus disclosed in reference to FIGS. 13A and 13B are provided by way of illustration, not by way of limitation, and that other means to provide removable engagement between a cutting means 250 and the drive cable 210 also fall within the scope of the present invention.

FIG. 15 illustrates a second embodiment of a cutting device 100 which may be used in conjunction with cutting means 250 according to the present invention. While the cutting device 100 of FIG. 14 include several similar elements to that described previously, further different elements and the manner of operation may differ slightly. With reference to FIG. 14, the cutting device 100 comprises a drive means 300 having a rotating output shaft 305, which in turn is connected to an intermediate clutch 307, which in turn is connected to driveshaft 310. Where the drive means 300 does not require intermediate clutch, the drive means 300 can be directly connected to the drive shaft 310. Driveshaft 310 includes at an end thereof a drive worm 129 which is enmeshed with a worm gear 128 on one side of a wheel 121. An off-center link shaft 125 is operatively coupled to an end of a crank arm 140, the other end of which is operatively coupled to the base of a rack frame 400 having two spaced apart gear racks 410, 420 extending outwardly therefrom. The cutting device 100 further includes a pair of spaced apart drive cable wheels 430A, 430B, from the periphery of each extends a drive cable 210. Between a drive gear 435A, 435B coupled to and coaxially mounted to a corresponding drive cable wheel 430A, 430B, is an intermediate coupling gear 440A, 440B engaged with one of the gear racks 410, 420, whereby the reciprocating motion of the rack frame 400 and gear racks 410, 420 causes partial rotation of a reciprocating nature to the drive cable wheels 430A, 430B and the attached drive cables 210. This motion is in part represented by the arrows present in FIG. 14. A cutting means 250 is coupled at its ends to the attached drive cables 210 and is driven in a reciprocating or back-and-fourth manner while the cutting device 100 operates. A part of the cutting to means 250 is wrapped around a peripheral surface of an article being cut, here a pipe P.

The present invention may be embodied in other specific forms without departing from its spirit or essential characteristics. The described embodiments are to be considered in all respects only as illustrative and not restrictive. The scope of the invention will be, therefore, indicated by claims rather than by the foregoing description. All changes, which come within the meaning and range of equivalency of the claims, are to be embraced within their scope.

1. A cutting device, comprising:
a drive means;
a drive assembly operably coupled to and powered by the drive means, the drive assembly comprising:
a worm gear operably coupled to and driven by the drive means;
a crank assembly operably coupled to and driven by the worm gear;
a timing assembly operably coupled to and driven by the crank assembly;
an actuator assembly operably coupled to and driven by the timing assembly; and
a crank arm operably coupled to the crank assembly and the timing assembly;
a drive cable extending from and operably coupled to the actuator assembly; and
a cutting means operably coupled to the drive cable, the cutting means being flexible;
wherein the drive assembly is configured such that a reciprocating motion is transmitted to the cutting means such that the cutting means is reciprocated for cutting an article.

2. The cutting device of claim 1,
wherein the crank assembly includes a central shaft extending therethrough at a substantially central location and a first link shaft extending therefrom, the first link shaft being offset from the central location;
wherein the timing assembly includes a support shaft extending therethrough at a substantially central location and a second link shaft extending therefrom, the second link shaft being offset from the central location; and
wherein the crank arm is operably coupled to the first and second link shafts such that the crank assembly is fully rotatable in a first direction while the timing assembly is partially rotatable in the first direction and partially rotatable in a second direction.

3. The cutting device of claim 2, wherein the actuator assembly is rotatable in the first direction when the timing assembly rotates in the second direction and the actuator assembly is rotatable in a second direction when the timing assembly rotates in a first direction.

4. The cutting device of claim 3, wherein the drive cable is operably coupled to the actuator assembly such that the drive cable moves in a reciprocating motion when the actuator assembly is displaced.

5. The cutting device of claim 4, wherein the drive cable includes two sections, each section operably coupled to the actuator assembly, wherein one section of the drive cable is further extended from the actuator assembly while another section of the drive cable is retracted toward the actuator assembly during the reciprocating motion.

6. A cutting device, comprising:
a drive assembly;
a drive cable extending from and operably coupled to the drive assembly; and
a cutting means operably coupled to the drive cable, the cutting means being flexible;
wherein the drive assembly is configured such that a reciprocating motion is transmitted to the cutting means.

7. The cutting device of claim 6, further comprising a drive means operably coupled to the drive assembly, the drive means configured to transmit a rotational force.

8. The cutting device of claim 7, wherein the drive means is powered by a power source selected from a group comprising electrical power and fuel power.

9. The cutting device of claim 7, wherein the drive assembly comprises:
a worm gear operably coupled to and driven by the drive means;
a crank assembly operably coupled to and driven by the worm gear;
a timing assembly operably coupled to and driven by the crank assembly;
an actuator assembly operably coupled to and driven by the timing assembly; and
a crank arm operably coupled to the crank assembly and the timing assembly.

10. The cutting device of claim 9, wherein the crank assembly includes a central shaft extending therethrough at a substantially central location and a first link shaft extending therefrom, the first link shaft being offset from the central location.

11. The cutting device of claim 10, wherein the timing assembly includes a support shaft extending therethrough at a substantially central location and a second link shaft extending therefrom, the second link shaft being offset from the central location.

12. The cutting device of claim 11, wherein the crank arm is operably coupled to the first and second link shafts such that the crank assembly is fully rotatable in a first direction while the timing assembly is partially rotatable in the first direction and partially rotatable in a second direction.

13. The cutting device of claim 12, wherein the actuator assembly is rotatable in the first direction when the timing assembly rotates in the second direction and the actuator assembly is rotatable in the second direction when the timing assembly rotates in the first direction.

14. The cutting device of claim 13, wherein the drive cable is operably coupled to the actuator assembly such that the drive cable is moves in a reciprocating motion when the actuator assembly is displaced.

15. The cutting device of claim 14, wherein the drive cable includes two sections, each section operably coupled to the actuator assembly, wherein one section of the drive cable is further extended from the actuator assembly while another section of the drive cable is retracted toward the actuator assembly during the reciprocating motion.

16. A cutting device, comprising:
a drive assembly;
a drive cable having a cutting means, the drive cable extending from and operably coupled to the drive assembly, the drive cable being flexible;
wherein the drive assembly is configured such that a reciprocating motion is transmitted to the drive cable.

17. The cutting device of claim 16, wherein the drive assembly comprises:
a first gear assembly having a first link shaft extending therefrom;
a second gear assembly having a second link shaft extending therefrom, the second gear assembly operably coupled to the first gear assembly; and
a crank arm operably coupled to the first and second link shafts.

18. The cutting device of claim 17, wherein the first and second link shafts are positioned such that the first gear assembly is fully rotatable in a first direction while the second gear assembly is partially rotatable in the first direction and partially rotatable in a second direction.

19. The cutting device of claim 18, the drive cable is operably coupled to the second gear assembly such that the drive cable moves in a reciprocating motion when the first and second gear assemblies are displaced.

20. The cutting device of claim 19, wherein the drive cable includes two sections, each section operably coupled to the second gear assembly, wherein one section of the drive cable is further extended from the second gear assembly while another section of the drive cable is retracted toward the second gear assembly during the reciprocating motion.
